(19) United States
(12) Patent Application Publication
(10) Pub. No.: US 2011/0074121 A1
(43) Pub. Date: Mar. 31, 2011

(54) CHUCK WITH STATIONARY ACTUATOR

(76) Inventor: Eugen HANGLEITER, Hermaringen (DE)

(21) Appl. No.: 12/885,844

(22) Filed: Sep. 20, 2010

(30) Foreign Application Priority Data
Sep. 25, 2009 (DE) 102009044105.0

(51) Int. Cl. B23B 31/16

(52) U.S. Cl. 279/66

(57) ABSTRACT

A chuck has a stationary support and a spindle rotatable in the support and having forward therefrom a forwardly open seat for a workpiece. A plurality of jaws are shiftable in the support to grip or release the workpiece. A pull rod coupled to the jaws projects rearward therefrom and carries a central plate. A rear plate spaced rearward of the central plate is rotationally fixed to the spindle. A push rod axially shiftable in the rear plate has a front end engageable with the central plate and a rear end projecting rearward from the rear plate. A spring braced between the spindle and the central plate urges the central plate rearward. A piston is shiftable in the support between a front position bearing forward opposite to the spring on the push rod and therethrough on the central plate and a rear position spaced rearward of the push rod.

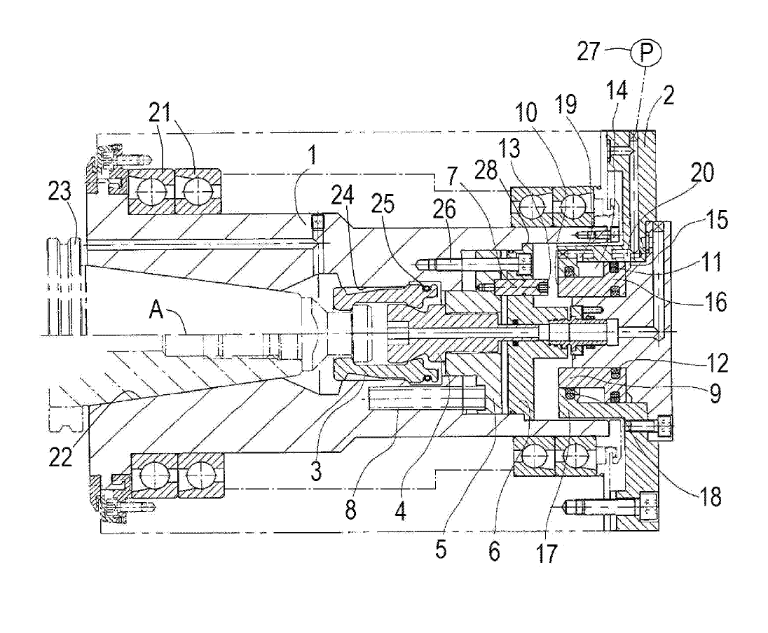

### FIELD OF THE INVENTION

The present invention relates to chuck. More particularly this invention concerns a chuck with a stationary actuator.

### BACKGROUND OF THE INVENTION

A typical chuck has a generally stationary support and a spindle centered on an axis and rotatable in the support about the axis. This spindle forming a central guide and having forward therefrom a forwardly open seat for a tool or workpiece. A plurality of jaws are shiftable along the guide between an inner position closely radially juxtaposed and capable of gripping the tool or workpiece in the seat and an outer widely radially juxtaposed position in which the tool or workpiece can be shifted into or out of the seat. A pull rod coupled to the jaws and projecting rearward therefrom.

An actuator is connected between the pull rod and the support and serves to axially displace it. This actuator is frequently a source of problems because it must transmit axial force between a nonrotating support and a rotating rod, with the later often moving a high speed. Thus at least a part of the actuator must be fixed or nonrotating, and another must be able to act on a rotating part without heat buildup or damage.

### OBJECTS OF THE INVENTION

It is therefore an object of the present invention to provide an improved chuck with a fixed actuator.

Another object is the provision of such an improved chuck with a fixed actuator that overcomes the above-given disadvantages, in particular that is of simple and reliable construction, yet which ensures actuation of the chuck even when used at high speed. As a result the assembly is often quite long and complicated.

### SUMMARY OF THE INVENTION

A chuck has according to the invention a generally stationary support and a spindle centered on an axis, rotatable in the support about the axis, forming a central guide, and having forward therefrom a forwardly open seat for a tool or workpiece. A plurality of jaws are shiftable along the guide between an inner position closely radially juxtaposed and capable of gripping the tool or workpiece in the seat and an outer widely radially juxtaposed position in which the tool or workpiece can be shifted into or out of the seat. A pull rod coupled to the jaws projects rearward therefrom. A central plate is carried on the pull rod, and a rear plate spaced rearward of the central plate is rotationally fixed to the spindle. At least one push rod axially shiftable in the rear plate has a front end engageable with the central plate and a rear end projecting rearward from the rear plate. At least one spring braced between the spindle and the central plate urges the central plate, push rod, pull rod, and jaws rearward into the rear locking position of the jaws. A cylindrically tubular piston axially is shiftable in the support between a front position bearing axially forward opposite to the spring on the push rod and therethrough on the central plate, pull rod, and jaws and a rear position axially spaced rearward of the push rod.

This configuration has the advantage that the pull rod can be very short. Another advantage is that due to the annular face of the cylindrical piston, the push rod can be subjected to load in any rotational position of the spindle. Since, however, the actuator is only engaged with the push rod or rods to open the chuck, that is to release a tool or workpiece or take in a fresh tool or workpiece, it is acting on a stationary spindle assembly since tools or workpieces are only changed in a nonrotating chuck.

It has proven to be advantageous for the chuck if the cylindrical piston has an annular rear flange with a first slide-type ring seal projecting outward and a second slide-type ring seal projecting inward so that the movability and guidance of the cylindrical piston can be improved.

Furthermore, the actuator can include a front compartment between a front face of the flange of the cylindrical piston and a flange of the support confronting the spindle, and a rear release compartment behind the cylindrical piston's annular base flange opposite the gripping compartment, and that a third slide-type seal ring projects inward of the annular support flange against the piston.

### BRIEF DESCRIPTION OF THE DRAWING

The above and other objects, features, and advantages will become more readily apparent from the following description, reference being made to the accompanying drawing whose sole FIGURE is a partly schematic longitudinal cross section through the invention.

### SPECIFIC DESCRIPTION

A chuck according to the invention has a spindle 1 supported by bearings 21 in a stationary support 2 for rotation about an axis A on which the spindle 2 is centered and along which it extends. The spindle 1 is formed at an axial front (left in the drawing) end with a rearwardly tapered seat 22 for a tool or workpiece 23. Generally centrally it forms a standard guide 24 for an array of jaws 3 that can be shifted between the illustrated rear position in which they grip and lock the tool or workpiece 23 in the seat 22 and an unillustrated forward position in which they are radially spread so the tool or workpiece 12 can move in and out of the seat 22. A small coil spring 25 biases the jaws 3 into the spread position.

A pull rod 4 axially shiftable in the spindle 1 has a front end engaging the jaws 3 and shaped to be able to shift them axially between their illustrated rear locking position and their unillustrated front releasing position. This rod 4 has a rear end fixed, typically by a screwthread, in a ring 5 that is axially shiftable in the spindle 1 but prevented from rotating relative thereto by axially extending bolts 26 screwed into the spindle 2. At least one compression spring 8, normally an array of angularly spaced such springs 8, is braced axially between respective front seats in the spindle 1 and respective rear seats in the plate 5 so that the jaws 3 are forcibly biased into the rear locking position. The heads of the bolts 26 forwardly press a closing ring or plate 6 through which extends at least one push rod 7, normally an annular array of angularly spaced such rods 7, against a rearwardly directed shoulder 28 of the spindle 2 to axially and rotationally fix the plate 6 in the spindle 2. The front end of each push rod 7 is screwed into a respective seat in the ring 5 and its rear end 13 projects from the rear face of the plate 6. Thus a forward pressure on the push rods 7 will be effective on the ring 5 and through it on the rod 4 to move the jaws 3 against the force of their springs 8 into the forward releasing position. This is all generally standard and all the above-described parts rotate jointly with the spindle 3 about the axis A.

According to the invention a fixed actuator is formed by an annular piston 9 that can shift axially in but that does not rotate relative to the stationary support 2. This piston 9 has a front face 10 that lies in a plane parallel to the rear faces of the rear ends 13 of the rods 7. It also has a rear flange 16 provided with seal rings 11 and 12 that define in the support 2 a pressurizable rear compartment 15 and a front flange 17 that forms a front compartment 14 sealed by a seal ring 18 of the support 2. Pump means shown schematically at 27 is connected to the compartments 14 and 15 by conduits 19 and 20 formed in the fixed support 2 to pressurize one or the other of these compartments 14 and 15.

When according to the invention the rear compartment 15 is pressurized, the piston 9 moves out of its illustrated rear position into a front position engaging the rear ends 13 of the rods 7, pressing them, the ring 5, the rod 4, and the jaws 3 forward to move these jaws 3 against the force of the springs 8 into the front releasing position. When the front compartment 14 is pressurized the piston 9 withdraws to the illustrated position and the springs 8 move the parts back into the rear locking position.

Thus pressurization of the rear compartment 15 opens the chuck so that it can receive or release a tool or workpiece 23. Pressurization of the front compartment 14 allows the springs 8 to close the chuck and clamp the tool or workpiece 23. Once the chuck is closed, the actuator is out of contact with the rotating parts, and in fact this closed compartment can be maintained simply by not letting fluid into or out of the compartments 14 and 15.

I claim:

1. A chuck comprising:
a generally stationary support;
a spindle centered on an axis, rotatable in the support about the axis, forming a central guide, and having forward therefrom a forwardly open seat for a tool or workpiece;
a plurality of jaws shiftable along the guide between an inner position closely radially juxtaposed and capable of gripping the tool or workpiece in the seat and an outer widely radially juxtaposed position in which the tool or workpiece can be shifted into or out of the seat;
a pull rod coupled to the jaws and projecting rearward therefrom;
a central plate carried on the pull rod;
a rear plate spaced rearward of the central plate and rotationally fixed to the spindle;
at least one push rod axially shiftable in the rear plate and having a front end engageable with the central plate and a rear end projecting rearward from the rear plate;
spring means braced between the spindle and the central plate for urging the central plate, push rod, pull rod, and jaws rearward into the rear locking position of the jaws; and
a piston axially shiftable in the support between a front position bearing axially forward opposite to the spring means on the push rod and therethrough on the central plate, pull rod, and jaws and a rear position axially spaced rearward of the push rod.

2. The chuck defined in claim 1 wherein the support and piston form a rear compartment pressurizable to move the piston into the respective front position.

3. The chuck defined in claim 2 wherein the support and the piston form a front compartment pressurizable to move the piston into the respective rear position.

4. The chuck defined in claim 3 further comprising ring seals between the piston and the support.

5. The chuck defined in claim 3 wherein the piston has a radially outwardly projecting rear flange delimiting the rear compartment.

6. The chuck defined in claim 5, further comprising inner and outer ring seals on the piston at the flange, the inner ring seal bearing radially inward on the support and the outer ring seal bearing radially outward on the support.

7. The chuck defined in claim 3 wherein the housing has a radially inwardly projecting front flange delimiting the front compartment.

8. The chuck defined in claim 7, further comprising an inner ring seal on the front flange bearing radially inward on the piston.

9. The chuck defined in claim 1, further comprising
guide bolts extending axially through the rear and central plates and seated in the spindle for rotationally coupling the rear and central plates to the spindle for joint rotation, the central plate being axially slidable on the guide bolts and the rear plate being axially fixed on the guide bolts.

10. The chuck defined in claim 9 wherein the spindle is formed with a rearwardly directed shoulder against which the guide bolts press the rear plate.
